(19) United States
(12) Patent Application Publication
(10) Pub. No.: US 2005/0168576 A1
(43) Pub. Date: Aug. 4, 2005

(54) Monitor device and monitor system

(76) Inventor: Junichi Tanahashi, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/514,978

(22) PCT Filed: May 19, 2003
(86) PCT No.: PCT/JP03/06186

(30) Foreign Application Priority Data
May 20, 2002 (JP) 2002-144344
Oct. 28, 2002 (JP) 2002-312743

(51) Int. Cl. H04N 7/18

(52) U.S. Cl. 348/159

(57) ABSTRACT

A monitor system (10) comprising a center server (12) and a dedicated terminal (14). The center server (12) comprises a moving image database (43) in which a moving data file sent from the dedicated terminal (14) via the Internet (16) is stored. The dedicated terminal (14) includes a hard disk (22) and is connected to a TV monitor (29), a monitor camera (36), and an emergency detection switch (37). The dedicated terminal (14) comprises means for storing the video from the monitor camera (36) onto the hard disk (22) as a normal-image-quality moving image data file; means for transferring the file to the center server (12); means for temporarily storing the video onto the hard disk (22) as relatively-high-quality moving image data; means for storing high-quality moving image data for five minutes before and after an input from the event detection switch (37) onto the hard disk (22) as a file; and means for transferring the file to the center server (12).

### TECHNICAL FIELD

This invention relates to a monitoring technology and, particularly to a monitor device of the type in which the image data imaged by a monitor camera are stored in a hard disk and to a monitor system.

### BACKGROUND ART

Nowadays, anti-burglar monitor cameras have been installed in many banks and stores such as convenience stores, consumer's finalcial shops, etc.

For example, the monitor cameras are installed near the inlet and exit of shops and near the cashiers to record the visitors in a video tape at all times, so that, in case a crime or an accident should occur, the circumstances can be analyzed later in detail to specify the culprit.

Accompanying an increase in heinous crimes in recent years, monitor cameras have been installed even in schools and in general households.

According to the conventional monitor systems, however, the images are recorded in a video tape as described above requiring laborious work and space for preserving and rearranging the video tapes.

The video tapes, however, are liable to be lost due to fire, earthquakes, theft, etc., and may not often serve as evidence materials.

It is technically possible to transmit images input through monitor cameras to a computer system installed in a safe place through a dedicated circuit to back up the data in real time, which, however, is expensive to employ on a real business basis.

In the case of, for example, a consumer financial company having more than 1000 shops nationwide, the amount of image data transmitted from several monitor cameras installed in each shop becomes a tremendous quantity which cannot be preserved 24 hours everyday a whole year from the standpoint of cost vs. effect.

This invention was contrived to solve the above problems inherent in the conventional monitor systems, and has an object of realizing a monitor device capable of easily and effectively saving the image data input through the monitor cameras without using video tapes.

The invention further has an object of providing a system capable of transferring the image data input through monitor cameras to a remote place in real time to safely save the data, and of effectively utilizing the image data should an emergency arise, at relatively low costs.

### DISCLOSURE OF THE INVENTION

In order to achieve the above objects, a monitor device according to a first aspect of the invention incorporates a hard disk and has a TV monitor, a monitor camera and an emergency detection switch thereto, and further comprises:
means for converting the image input through the monitor camera into a moving image file of a normal image quality and for storing the moving image file into the hard disk;
means for converting the image input through the monitor camera into moving image data of a relatively high image quality and for storing the moving image data in the hard disk;
means which, when there is an input from the emergency detection switch, forms the moving image data of the high image quality of a preset period of time before and after the moment of emergency into a file thereof, and stores the file in the hard disk; and
means for reproducing the moving image file stored in the hard disk through the TV monitor.

The monitor device is of the type in which the image input through the monitor camera is saved in the hard disk that is incorporated therein. Therefore, there is no need of using a video tape, and the preservation thereof and the rearrangement thereof are not required, either.

Usually, the image from the monitor camera is saved as a moving image file of a normal image quality and of a relatively small amount of data. Should an emergency arise, the moving image file is saved maintaining a relatively high image quality retroactive to the past by a predetermined period of time. The disk capacity is, usually, curtailed, but highly fine images are preserved for the important scenes.

A monitor device according to a second aspect of the invention is based on the monitor device of the first aspect, wherein a plurality of monitor cameras are connected via a switcher, and a moving image file of a normal image quality and a moving image file of a high image quality are formed based on the images input from the monitor cameras.

As a result, a plurality of places can be simultaneously monitored, and their image files can be saved.

A monitor device according to a third aspect of the invention is based on the monitor device of the first or second aspect, wherein a microphone is connected, and provision is made of means for forming a moving image file with voice of a normal image quality based on the voice input through the microphone, and means for forming a moving image file with voice of a high image quality based on the voice.

A monitor device according to a fourth aspect of the invention is based on the monitor device of any one of the first to third aspect, wherein provision is made of means for deleting the moving image files stored in the hard disk in order of updating the imaging date and hour at a moment when the free capacity of the hard disk becomes smaller than a predetermined value.

As a result, new moving image files can be continuously stored in the incorporated hard disk having a limited capacity.

A monitor system according to a fifth aspect of the invention has a center server and a dedicated terminal connected to the center server through an internet, wherein:
the center server includes storage means for storing a moving image file transmitted from the dedicated terminal being correlated with the dedicated terminal;
the dedicated terminal incorporates a hard disk, and has a TV monitor, a monitor camera and an emergency detection switch connected thereto;
the monitor system further comprising:
means for converting the image input through the monitor camera into a moving image file of a normal image quality and for storing the moving image file into the hard disk;
means for transferring the moving image file of the normal image quality to the center server;
means for converting the image input through the monitor camera into moving image data of a relatively high quality and for storing the moving image data in the hard disk;
means which, when there is an input from the emergency detection switch, forms the moving image data of a high image quality of a preset period of time before and after the moment of emergency into a file, and stores the file in the hard disk;
means for transferring the moving image file of the high image quality to the center server; and
means for reproducing the moving image file stored in the hard disk through the TV monitor.

The monitor system is of the type in which the image input through the monitor camera is saved in the hard disk in the dedicated terminal. Therefore, there is no need of using a video tape, and the preservation thereof and the rearrangement thereof are not required, either.

Further, the moving image files are successively transferred to the center server through the internet and are backed up therein. Therefore, even in case the dedicated terminal is destroyed by fire or the like, the images shot by the monitor camera can be reliably reproduced later.

Usually, further, the image from the monitor camera is saved and transferred as a moving image file of a normal quality and of a relatively small amount of data. Should an emergency arise, the moving image file is saved maintaining a relatively high image quality retroactive to the past by a predetermined period of time to be transferred. The disk capacity and traffic amount are, usually, curtailed, but highly fine images are saved for the important scenes, and improved cost performance of the system as a whole can be expected.

A monitor system according to a sixth aspect is based on the monitor system of the fifth aspect, wherein the dedicated terminal includes:
a card reader for reading authentication data of a user and a dedicated terminal ID stored in an ID card; and
means for transmitting the authentication data and the dedicated terminal ID to the center server and for requesting the authentication of the user; and
the center server includes:
a user database for storing the authentication data of each user correlated with the dedicated terminal ID; and
means which, when the authentication data and the dedicated terminal ID are transmitted from the dedicated terminal, refers to the user database to execute the authentication processing.

A monitor system according to a seventh aspect is based on the monitor system of the fifth or sixth aspect, wherein a plurality of monitor cameras are connected to the dedicated terminal via a switcher, and a moving image file of a normal image quality and a moving image file of a high image quality are formed based on the images input from the monitor cameras.

A monitor system according to an eighth aspect is based on the monitor system of any one of the fifth to seventh aspects, wherein a microphone is connected to the dedicated terminal, and provision is made of means for forming a moving image file with voice of a normal image quality based on the voice input through the microphone, and means for forming a moving image file with voice of a high image quality based on the voice.

A monitor system according to a ninth aspect is based on the system of any one of the fifth to eighth aspects, wherein the dedicated terminal comprises:
means for requesting the center server to transmit data related to a moving image file;
means for forming a list of moving image files based on the data transmitted from the center server; and
means which, when a user selects a particular moving image file in the list, requests the center server to deliver the above moving image file; and
the center server comprises:
means which, when requested by the dedicated terminal to transmit the data related to a moving image file, picks up, from the storage means, the data related to the moving image file correlated with the dedicated terminal, and transmits the data to the dedicated terminal; and
means which, when requested by the dedicated terminal to deliver a particular moving image file, picks up, from the storage means, the above moving image file, and transmits the moving image file to the dedicated terminal.

As a result, the user is allowed to reproduce the moving image file backed up in the center server at any time by using his own dedicated terminal.

A monitor system according to a tenth aspect of the invention is based on the monitor system of any one of the fifth to ninth aspect, wherein the dedicated terminal is further provided with means for deleting the moving image files stored in the hard disk in order of updating the imaging date and hour at a moment when the free capacity of the hard disk becomes smaller than a predetermined value.

As a result, new moving image files can be continuously stored in the hard disk having a limited capacity in the dedicated terminal.

A monitor system according to an eleventh aspect of the invention is based on the monitor system of any one of the fifth to tenth aspect, wherein the dedicated terminal further includes means for recording the data of imaging date and hour on the frames of the moving image file, and the center server includes means for recording the data of date and hour when the moving image file transmitted from the dedicated terminal is to be stored in the storage means.

As a result, in case the reliability of the moving image file becomes a problem, the data of date and hour imprinted on the image can be collated with the data of date and hour recorded in the center server side to verify the date and hour the moving image file is shot.

A monitor system according to a twelfth aspect of the invention is based on the monitor system of any one of the fifth to eleventh aspect, wherein the center server includes means for continuously transmitting the data of date and hour to the dedicated terminal, and the dedicated terminal includes means which successively describes the data of date and hour transmitted from the center server onto a packet of the moving image file transmitted to the center server. The center server stores the data of date and hour described on the packet of the moving image file in the present data base.

By comparing the data of date and hour described on the packet of the moving image file with the data of date and hour recorded in the moving image file, therefore, correctness of the date and hour of shooting the image can be verified, and the moving image file acquires an enhanced value of evidence.

A monitor system according to a thirteenth aspect of the invention is based on the monitor system of any one of the fifth to twelfth aspect, wherein the center server includes means for monitoring the operation for recording the data of imaging date and hour in the dedicated terminal and for recording the monitored record in a predetermined database.

In this case, too, with the data being described in the monitored record indicating that the dedicated terminal was normally operating, it is allowed to prove the correctness of the data of date and hour of shooting the moving image file, and the moving image file acquires an enhanced value of evidence.

### BRIEF DESCRIPTION OF THE DRAWINGS

FIG. 1 is a schematic view of a whole image of a monitor system according to the invention;

FIG. 2 is a block diagram illustrating a hardware constitution of a dedicated terminal;

FIG. 3 is a block diagram illustrating a functional constitution of a monitor system;

FIG. 4 is a flowchart illustrating a procedure of processing in the monitor system;

FIG. 5 is a diagram illustrating the essentials for filing in an emergency mode;

FIG. 6 is a diagram of layout illustrating a list of moving image files in a normal operation; and

FIG. 7 is a diagram of layout illustrating a list of moving image files in an emergency operation.

### BEST MODE FOR CARRYING OUT THE INVENTION

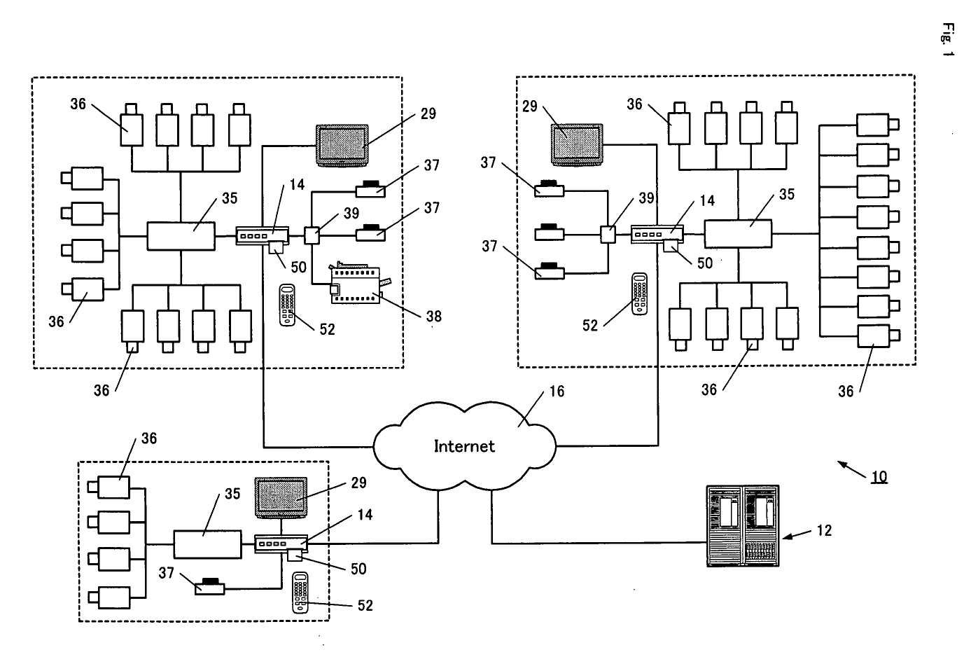

FIG. 1 shows the whole image of a monitor system 10 according to the invention which includes a center server group 12 managed by the operator of the system and a dedicated terminal (set top box/STB) 14 installed in each office or house.

The center server group 12 is, in practice, formed by connecting a plurality of computers through a network, and possesses a WWW (worldwide web) server function, a moving image contents delivery server function, a database server function, a mail server function, an authentication server function and a time server function.

The center server group 12 and each dedicated terminal 14 are connected through an internet 16. More concretely speaking, each dedicated terminal 14 is connected to the internet 16 via a server of an internet service person (ISP) for which the user is a subscriber (not shown).

The server of the ISP and the dedicated terminal 14 are connected together at all times through a so-called broad band network of a high speed and a large capacity, such as an ADSL or an optical fiber.

A system utilization agreement has been signed in advance between the operator of the system and the user.

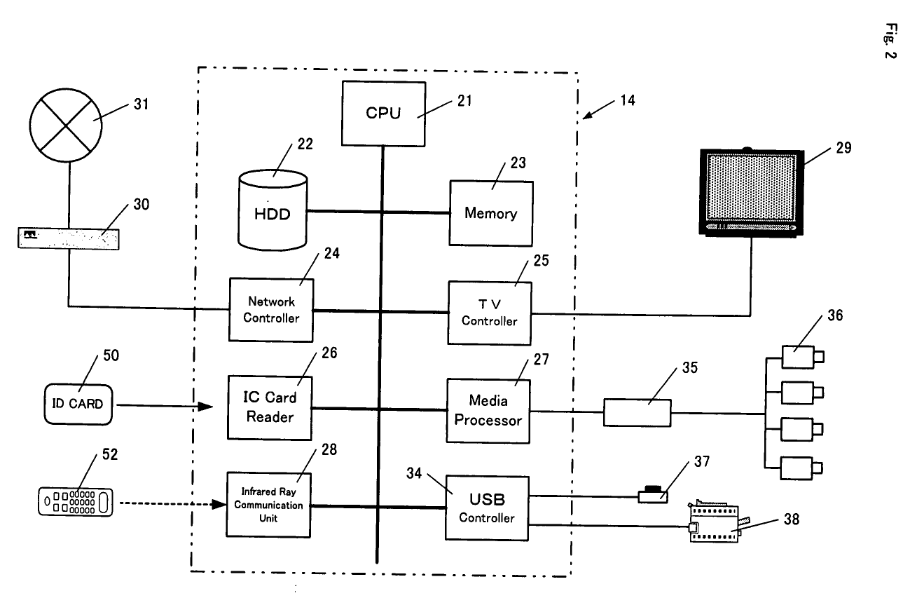

FIG. 2 is a block diagram illustrating the hardware constitution of the dedicated terminal 14, which includes a CPU 21, a hard disk 22, a memory (ROM, RAM) 23, a network controller 24, a TV controller 25, an IC card reader 26, a media processor 27, an infrared ray communication unit 28 and a USB controller 34, which are connected to the CPU 21 via a system bus.

A general TV monitor 29 is connected to the TV controller 25 via an input/output terminal and a connection cable.

Further, a broad band modem 30 is connected to the network controller 24. The network controller 24 is connected to the internet 16 through the broad band modem 30 and the broad band network 31.

Monitor cameras 36 with microphone can be connected in a number of 1 to 16 to the media processor 27 through a switcher 35. The media processor 27 has a function of encoding/decoding the moving image data and voice data in real time, and to which is connected a memory (not shown) dedicated for processing the images.

Further, an emergency detection switch 37 and a printer 38 are connected to the USB controller 34. It is also allowable to connect a plurality of emergency detection switches 37 to the dedicated terminal 14 through a USB hub 39 (FIG. 1).

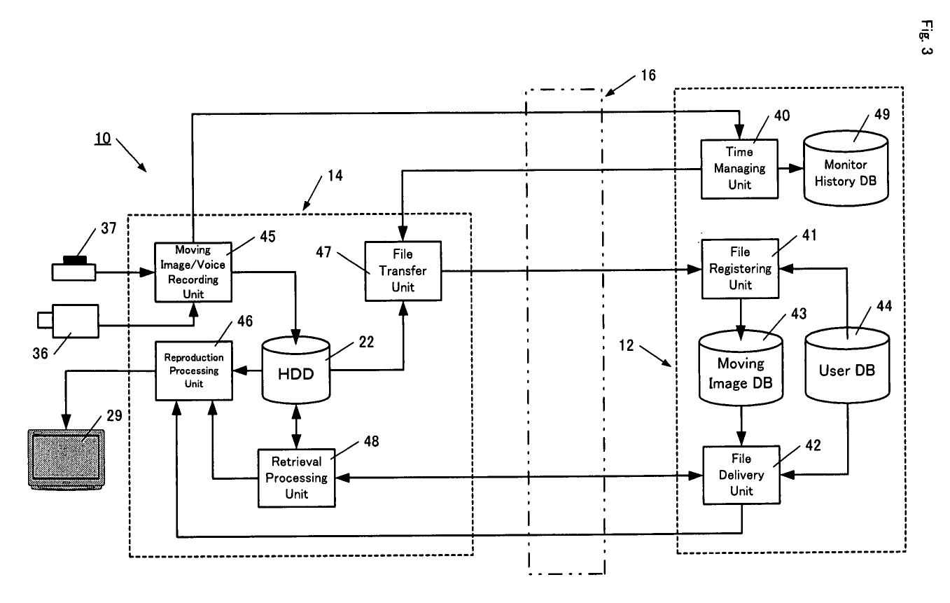

FIG. 3 is a block diagram illustrating the functional constitution of the monitor system 10 in which the center server group 12 includes a time management unit 40, a file registration unit 41, a file delivery unit 42, a moving image database 43, a user database 44, and a monitor history database 49.

The time management unit 40, file registration unit 41 and file delivery unit 42 are realized when a CPU in the computer constituting the group of center servers 12 executes a necessary processing according to an OS and a dedicated program.

The moving image database 43, user database 44 and monitor history database 49 are stored in a hard disk in the computer that constitutes the center server group 12.

The dedicated terminal 14 includes a moving image/voice recording unit 45, a reproduction processing unit 46, a file transfer unit 47 and a retrieval processing unit 48.

The moving image/voice recording unit 45, reproduction processing unit 46, file transfer unit 47 and retrieval processing unit 48 are realized when the CPU 21 in the dedicated terminal 14 or the media processor 27 executes a necessary processing according to an OS and a dedicated program stored in the memory 23 or in the hard disk 22.

An ID card (smart card) 50 has been distributed in advance to each user together with the dedicated terminal 14. In the ID card 50, there are recorded authentication data such as a MAC address of the dedicated terminal 14, a user ID and a password.

In the user database 44 in the center server group 12, further, there are registered at least an ID of each user, a password and a MAC address of the dedicated terminal 14.

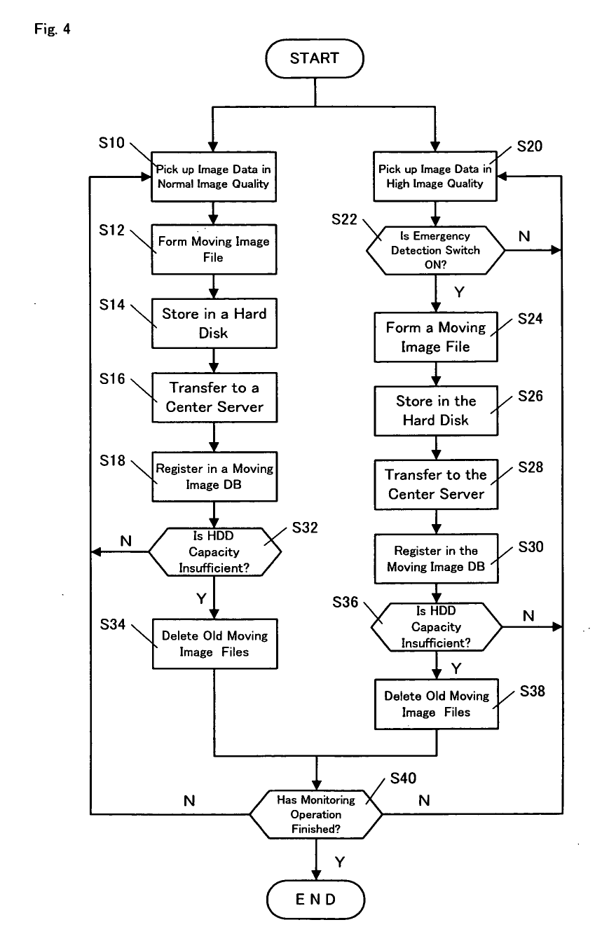

The procedure of processing in the monitor system 10 will now be described with reference to a flowchart of FIG. 4.

To utilize the monitor system 10, first, the user inserts the ID card 50 delivered to him in the IC card reader 26 in the dedicated terminal 14.

As a result, the user ID, password and MAC address of the dedicated terminal 14 recorded in the ID card 50 are transmitted to the center server group 12 from an authentication request unit (not shown) in the dedicated terminal 14 through the internet 16.

Upon receipt of this, an authentication processing unit (not shown) in the center server group 12 compares the data with the authentication data recorded in the user database 44 and checks the correctness.

When the step of authentication is cleared, the dedicated terminal 14 is connected to the center server group 12 through the network, and the dedicated terminal 14 becomes fully accessible from the center server group 12.

Thereafter, the moving image/voice recording unit 45 encodes the moving image data and voice data input from the monitor cameras 36 in the form of an MPEG4 and stores them in the hard disk 22.

Here, the moving image/voice recording unit 45 encodes the image data from the monitor cameras 36 in two kinds of modes of different image qualities, and stores them in the hard disk 22.

A first recording mode is a “normal mode” in which the image data are picked up in a normal image quality of, for example, a frame rate of 1 fps and a bit rate of 100 kbps (S10), and a moving image file with voice is formed in an amount of every predetermined period of time (e.g., every hour)(S12).

The moving image file of the normal image quality is stored in the hard disk 22 being correlated with the imaging time-zone data (S14).

The moving image files with voice of the normal image quality stored in the hard disk 22 are successively transferred by the file transfer unit 47 to the center server group 12 through the internet 16 (S16).

Upon receipt of the moving image files, the file registering unit 41 stores them in the moving image database 43 while imparting the ID of the dedicated terminal 14 and the present time data to them (S18).

Therefore, the image data of the normal mode input through the monitor camera 36 installed in a bank or in a shop such as consumer's financial shop, are recorded in the hard disk 22 in the dedicated terminal 14 in order of date and hour and are, further, backed up and saved in the moving image database 43 in the center server group 12.

Simultaneously with the above recording operation, the reproduction processing unit 46 reads out the moving image file with voice stored in the hard disk 22 and displays the image on the screen of the TV monitor 29. The reproduction processing unit 46 further produces voice from the speaker of the TV monitor 29.

When a plurality of monitor cameras 36 are connected to the dedicated terminal 14 via the switcher 35, the images input through the monitor cameras 36 can be displayed in a split manner on the TV monitor 29, or the image from a particular monitor camera 36 only can be displayed on the whole screen.

A second recording mode is an “emergency mode” in which the moving image/voice recording unit 45 picks up the image data in a relatively high image quality of, for example, a frame rate of 5 fps and a bit rate of 500 kbps (S20) and stores them in the hard disk 22 being correlated with the present time.

In the case of the emergency mode, however, the image data are temporarily stored in only a preset amount of disk capacity (e.g., 10 GB) in the hard disk 22, and on which the image data are successively overwritten unless there is no input from the emergency detection switch 37 during that period.

Should an emergency arise, such as shop robbery, on the other hand, a clerk in the shop depresses the emergency detection switch 37 installed on, for example, the back side of the desk.

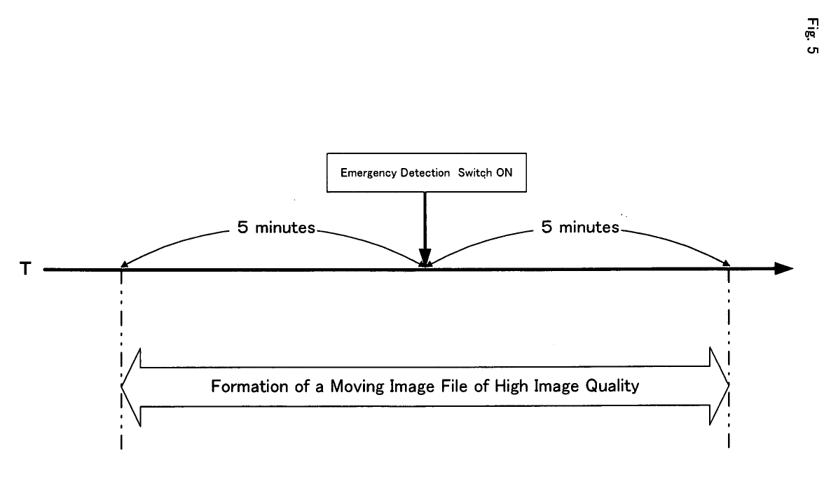

Upon receipt of an input signal from the emergency detection switch 37 (S22), the moving image/voice recording unit 45 stores, in a predetermined directory of the hard disk 22 (S26), the image data of a high image quality recorded in the emergency mode as a file over a period of a total of 10 minutes including 5 preceding minutes and 5 succeeding minutes from the occurrence as shown in FIG. 5 (S24).

At the same time, the file transfer unit 47 transfers the moving image file with voice of the high image quality to the center server group 12 through the internet 16 (S28).

Upon receipt of this, the file registering unit 41 backs up and saves the moving image file of the high image quality in the moving image database 43 being correlated with the present time (S30).

As described above, the image data during the normal operation are stored in the hard disk 22 as a moving image file of a relatively low image quality, and are transferred to the center server group 12, curtailing the capacity of the hard disk 22, reducing the traffic amount of transfer, and suppressing the initial cost and the running cost of the system as a whole.

Should an emergency arise, on the other hand, the moving image file of a high image quality is saved and transferred for 5 minutes retroactive to the past and for 5 minutes toward the future, allowing the moving image file to be effectively used as a material for searching crime.

The saving time of the moving image file of the high image quality in case of emergency is not limited to 10 minutes only but can be freely set to the memory 23 of the dedicated terminal 14 by the user through a remote control unit 52.

The hard disk 22 in the dedicated terminal 14 has a limited capacity. When the region (capacity) assigned in advance to the moving image file of the normal image quality recorded in the normal mode is filled up (S32), therefore, the moving image/voice recording unit 45 deletes the moving image files in order of updating the dates, and saves the new moving image files (S34).

It is desired that the moving image files of the high image quality recorded in the emergency mode, too, are deleted according to a predetermined rule to save the capacity of the disk.

For example, it can be contrived to delete the moving image files of the high image quality by the moving image/voice recording unit 45 in order of updating the files (S38) at a moment when, for example, a preset capacity is filled up (S36). Or, the moving image files of the high image quality can be deleted by the moving image/voice recording unit 45 in order of updating the files at a moment when a predetermined number of files (e.g., 10 files) or a term (e.g., a week) is exceeded.

The monitoring operation by the dedicated terminal 14 continues until the operation is interrupted by the user (S40).

The user is allowed to reproduce the moving image files stored in the hard disk 22 in the dedicated terminal 14 at any time.

In this case, the user selects the menu displayed on the TV monitor 29 via the remote control unit 52, and requests the dedicated terminal 14 to display the list of moving image files stored therein.

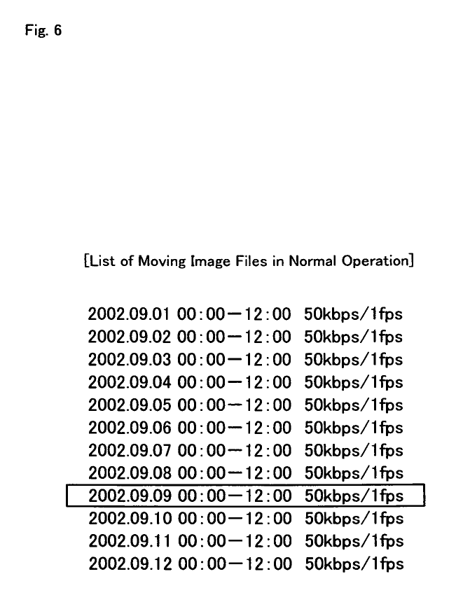

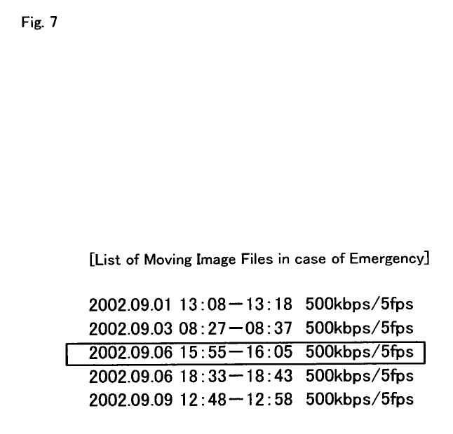

Upon receipt of this, the retrieval processing unit 48 picks up index data of moving image files stored in the hard disk 22, and displays the list on the TV monitor 29 as shown in FIGS. 6 and 7.

When the user selects a moving image file in a particular time zone by using the remote control unit 52, the reproduction processing unit 46 reproduces the moving image file and the mage is displayed on the TV monitor 29. At the same time, voice is output from the speaker of the TV monitor 29.

Through the remote control operation, further, the user can select any frame being reproduced and can color-print it by using the printer 38.

As required, further, the user can reproduce his own moving image file stored in the moving image database 43 of the center server group 12.

In this case, too, the user selects the menu displayed on the TV monitor 29 by using the remote control unit 52, and requests the dedicated terminal 14 to display the moving image file that is backed up and saved.

Upon receipt of this, the retrieval processing unit 48 requests the file distribution unit 42 in the center server group 12 to deliver the index data of the moving image file concerned with the user (dedicated terminal).

Upon receipt of this, the file distribution unit 42 refers to the moving image database 43, and transmits the index data of the moving image file correlated with the user to the dedicated terminal 14.

As a result, the retrieval processing unit 48 forms the moving image file lists same as those of FIGS. 6 and 7, and displays them on the TV monitor 29.

If the user selects the moving image file in a particular time zone by using the remote control unit 52, the moving image file is transmitted from the moving image file delivery unit 42 to the dedicated terminal 14 through the internet 16, and is displayed on the TV monitor 29 through the reproduction processing unit 46.

In the foregoing was described an embodiment in which a moving image file of the high image quality was saved in the emergency mode when the emergency detection switch 37 was depressed by a clerk of the shop. The system 10, however, is in no way limited thereto only.

Instead of the emergency detection switch, for example, various burglar sensors such as contactless switch, photoelectric switch, limit switch and the like switch are connected to a USB port of the dedicated terminal 14, it is so determined that an emergency has arisen in case there is an input therefrom, and the moving image data of the high image quality are saved as a file, backed up and are transferred.

Therefore, if, for example, somebody enters into the house at night and if a sensor detects this, then, a file of the high image quality is formed for 10 minutes preceding and succeeding the event, and is transferred to the center server group 12.

If the moving image file imaged by the monitor camera 36 is to be utilized as a material of evidence in a court at a later date, reliability of the data of imaging date with which the moving image file is correlated becomes very important in determining the value of the evidence.

Therefore, the moving image/voice recording unit 45 includes a function for imprinting the data of imaging date in each frame that constitutes the moving image at the time of encoding the image shot by the monitor camera 36.

It is further probable that the timekeeping circuit in the dedicated terminal 14 may not be on time. Further, it cannot be technically denied that the date is arbitrarily altered by the user. To maintain the reliability of the data of the imaged date, therefore, the monitor system 10 is provided with a function for monitoring the operation of imprinting the data of date in the dedicated terminal 14.

First, the dedicated terminal 14 is provided with a gadget which makes a regular access to the time server included in the center server group 12, and corrects the timepiece therein to record a correct data of date and hour onto each frame of the moving image file.

Further, when the moving image file is transferred from the dedicated terminal 14, the history of transmitting the moving image file from the user is recorded in the moving image database 43 together with the data of date by the file registering unit 41 in the center server group 12.

The history data of transmitting the moving image file and the moving image file are submitted in a pair in the court to verify the reliability of the data of date imprinted on the moving image file.

Or, the time managing unit 40 in the center serve group 12 may monitor, at all times, the operation for imprinting the data of date by the moving image/voice recording unit 45 in the dedicated terminal 14, and the monitored records may be successively recorded in the monitor history database 49.

In this case, too, the moving image file and the data showing that the moving image/voice recording unit 45 in the dedicated terminal 14 has properly operated to imprint the data of date, are submitted in a pair in the court to verify the reliability of the data of date imprinted on the moving image file.

Further, correct data of date are successively transmitted to the dedicated terminal 14 from the time managing unit 40 in the center server group 12, and the data of date are imprinted onto the IP packets that are transmitted from the file transmission unit 47 in the dedicated terminal 14.

Upon comparing the data of date with the data of date imprinted on the IP packets, the correctness of the data of date imprinted on the moving image file can be verified.

In the foregoing was described an example of network-connecting the dedicated terminal 14 to the center server 12 through the internet 16. It is, however, also allowable to utilize the dedicated terminal 14 as a stand-alone monitor device by separating it from the network.

In this case, it is not allowed to transfer the moving image file input from the monitor camera 36 to the center server 12 in real time or to back up and save the moving image file in the moving image database 43. It is, however, possible to save the moving image file in the hard disk 22 that is incorporated.

During the normal operation, the image file is saved in the normal image quality to curtail the capacity of the disk. Should an emergency arise, however, the image file of the high image quality is saved retroactively by a predetermined period of time, which is ideal.

Further, a gadget is provided to successively delete the moving image files in order of updating the imaging data before the capacity of the disk is filled up, making it possible to continuously save the latest monitored data.

### Industrial Applicability

The monitor device of the invention is of the type in which the image input through the monitor camera is saved in the hard disk that is incorporated therein. Therefore, there is no need of using a video tape, and the preservation thereof and the rearrangement thereof are not required, either.

Usually, the image from the monitor camera is saved as a moving image file of a normal image quality and of a relatively small amount of data. Should an emergency arise, the moving image file is saved maintaining a relatively high image quality retroactive to the past by a predetermined period of time. The disk capacity is, usually, curtailed, but highly fine images are saved for the important scenes.

The monitor system according to the invention is of the type in which the image input through the monitor camera is saved in the hard disk in the dedicated terminal. Therefore, there is no need of using a video tape for recording the image data, and the preservation thereof and the rearrangement thereof are not required, either.

Further, the moving image files are successively transferred to the center server through the internet and are backed up therein. Therefore, even in case the dedicated terminal is destroyed by fire or the like, the images shot by the monitor camera can be reliably reproduced later.

Usually, further, the image from the monitor camera is saved and transferred as a moving image file of a normal image quality and of a relatively small amount of data. Should an emergency arise, the moving image file is saved maintaining a relatively high image quality retroactive to the past by a predetermined period of time to be transferred. The disk capacity and traffic amount are, usually, curtailed, but fine images are saved for the important scenes, and improved cost performance of the system as a whole can be expected.

1. A monitor device incorporating a hard disk and having a TV monitor, a monitor camera and an emergency detection switch connected thereto, and further comprising:
means for converting the image input through the monitor camera into a moving image file of a normal image quality and for storing the moving image file into the hard disk;
means for converting the image input through the monitor camera into moving image data of a relatively high image quality and for storing the moving image data in the hard disk;
means which, when there is an input from the emergency detection switch, forms the moving image data of the high image quality of a preset period of time before and after the moment of emergency into a file thereof, and stores the file in the hard disk; and
means for reproducing the moving image file stored in the hard disk through the TV monitor.

2. A monitor device according to claim 1, wherein a plurality of monitor cameras are connected via a switcher, and a moving image file of a normal image quality and a moving image file of a high image quality are formed based on the images input from the monitor cameras.

3. A monitor device according to claim 1 or 2, wherein:
a microphone is connected; and
provision is made of:
means for forming a moving image file with voice of a normal image quality based on the voice input through the microphone; and
means for forming a moving image file with voice of a high image quality based on the voice.

4. A monitor device according to any one of claims 1 to 3, wherein provision is made of means for deleting the moving image files stored in the hard disk in order of updating the imaging date and hour at a moment when the free capacity of the hard disk becomes smaller than a predetermined value.

5. A monitor system including a center server and a dedicated terminal connected to the center server through an internet, wherein:
the center server includes storage means for storing a moving image file transmitted from the dedicated terminal being correlated with the dedicated terminal;
the dedicated terminal incorporates a hard disk, and has a TV monitor, a monitor camera and an emergency detection switch connected thereto;
and the monitor system further comprises:
means for converting the image input through the monitor camera into a moving image file of a normal image quality and for storing the moving image file into the hard disk;
means for transferring the moving image file of the normal image quality to the center server;
means for converting the image input through the monitor camera into moving image data of a relatively high quality and for storing the moving image data in the hard disk;
means which, when there is an input from the emergency detection switch, forms the moving image data of the high image quality of a preset period of time before and after the moment of emergency into a file, and stores the file in the hard disk;
means for transferring the moving image file of the high image quality to the center server; and
means for reproducing the moving image file stored in the hard disk through the TV monitor.

6. A monitor system according to claim 5, wherein the dedicated terminal includes:
a card reader for reading authentication data of a user and a dedicated terminal ID stored in an ID card; and
means for transmitting the authentication data and the dedicated terminal ID to the center server and for requesting the authentication of the user; and
the center server includes:
a user database for storing the authentication data of each user correlated with the dedicated terminal ID; and
means which, when the authentication data and the dedicated terminal ID are transmitted from the dedicated terminal, refers to the user database to execute the authentication processing.

7. A monitor system according to claim 5 or 6, wherein a plurality of monitor cameras are connected to the dedicated terminal via a switcher, and a moving image file of a normal image quality and a moving image file of a high image quality are formed based on the images input from the monitor cameras.

8. A monitor system according to any one of claims 5 to 7, wherein:
a microphone is connected to the dedicated terminal; and
provision is made of:
means for forming a moving image file with voice of a normal image quality based on the voice input through the microphone; and
means for forming a moving image file with voice of a high image quality based on the voice.

9. A monitor system according to any one of claims 5 to 8, wherein the dedicated terminal comprises:
means for requesting the center server to transmit data related to a moving image file;
means for forming a list of moving image files based on the data transmitted from the center server; and
means which, when a user selects a particular moving image file in the list, requests the center server to deliver the above moving image file; and
the center server comprises:
means which, when requested by the dedicated terminal to transmit the data related to a moving image file, picks up, from the storage means, the data related to the moving image file correlated with the dedicated terminal, and transmits the data to the dedicated terminal; and
means which, when requested by the dedicated terminal to deliver a particular moving image file, picks up, from the storage means, the above moving image file, and transmits the moving image file to the dedicated terminal.

10. A monitor system according to any one of claims 5 to 9, wherein the dedicated terminal is further provided with means for deleting the moving image files stored in the hard disk in order of updating the imaging date and hour at a moment when the free capacity of the hard disk becomes smaller than a predetermined value.

11. A monitor system according to any one of claims 5 to 10, wherein the dedicated terminal further includes means for recording the data of imaging date and hour on the frames of the moving image file, and the center server includes means for recording the data of date and hour when the moving image file transmitted from the dedicated terminal is to be stored in the storage means.

12. A monitor system according to any one of claims 5 to 11, wherein the center server includes means for continuously transmitting the data of date and hour to the dedicated terminal, and the dedicated terminal includes means which successively describes the data of date and hour transmitted from the center server onto a packet of the moving image file transmitted to the center server.

13. A monitor system according to any one of claims 5 to 12, wherein the center server includes means for monitoring the operation for recording the data of imaging date and hour in the dedicated terminal and for recording the monitored record in a predetermined database.
